(19) United States
(12) Patent Application Publication
(10) Pub. No.: US 2006/0092901 A1
(43) Pub. Date: May 4, 2006

(54) Method, system and device for routing and controlling packet data flow

(75) Inventor: Janne Parantainen, Helsinki (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation, Espoo (FI)

(21) Appl. No.: 10/531,489

(22) PCT Filed: Oct. 15, 2003
(86) PCT No.: PCT/FI03/00763

§ 371 Date: Oct. 13, 2005

(30) Foreign Application Priority Data
Oct. 15, 2002 (FI) 20021832

(51) Int. Cl. H04B 7/216

(52) U.S. Cl. 370/342; 370/432

(57) ABSTRACT

A method for routing MBMS (Multicast/Broadcast Multimedia Service) service data from a first network entity to a second network entity is presented. Accordingly, a system comprising a Gb interface between a first and a second network entity arranged to route MBMS service data over the Gb interface is presented. A device for routing data over the Gb interface is presented. The routing is enabled by defining a PFI (Packet Flow Identifier) and by creating a corresponding PFC (Packet Flow Context) for said MBMS service.

### CROSS-REFERENCE TO RELATED APPLICATION

This is the U.S. National Stage of International Application No. PCT/FI2003/000763 filed Oct. 15, 2003 and published in English on Apr. 29, 2004 under International Publication Number WO 2004/036837 and claiming priority from Finnish application 20021832 filed Oct. 15, 2002.

### BACKGROUND OF THE INVENTION

1. Technical Field

The present invention relates generally to telecommunication systems. In particular the invention concerns routing and controlling the flow of packet data transmissions in a mobile network.

2. Discussion of Related Art

3GPP (3^{rd} Generation Partnership Project) has recently published a specification for the 3 GPP system comprising either UTRAN (UMTS Terrestrial Radio Access Network) or GERAN (GSM/EDGE Radio Access Network) as a radio access network. The specification defines a new broadcast/multicast service titled MBMS (Multimedia Broadcast/Multicast Service) [1]. MBMS basic architecture is illustrated in FIG. 1 wherein CBC (Cell Broadcast Center) 102, CSE (Camel Service Environment) 108, OSA/SCS (Open Service Access) 112 and related reference points can be considered as optional functionalities. Accordingly, mandatory components for realizing a MBMS service are described next in reference to [2].

The SGSN (Serving GPRS Support Node) 120 executes user specific service control functions, concentrates individual users of the same MBMS service into a single MBMS service and maintains a single connection with the source of the MBMS data. The SGSN 120 may also authenticate users and authorize the usage of services based on subscription data from the HLR (Home Location Register) 106. The GGSN (Gateway GPRS Support Node) 122 terminates the MBMS GTP (GPRS Tunneling Protocol) tunnels from the SGSN 120 and links these tunnels via IP (Internet Protocol) multicast with the MBMS data source. The BM-SC (Broadcast/Multicast Service Center) 110 is an MBMS data source. The architecture also accepts other MBMS broadcast/multicast data sources and internal data sources 104 may directly provide their data. Data delivery by external sources 126 is controlled by Border Gateways (BG) 124 which may allow for example data from single addresses and ports to pass into the PLMN (Public Land Mobile Network) for delivery by an MBMS service. MBMS data may be scheduled in the BM-SC 110, for example, to be transmitted to the user every hour. It offers interfaces which can be utilized by a content provider 104, 114 in requesting data delivery to users. The BM-SC 110 may authorize and charge the content provider 104, 114. The Gmb reference point between BM-SC 110 and GGSN 122 enables the BM-SC 110 to exchange MBMS service control information with the GGSN 122. The Gmb reference point exists in order to carry the MBMS service information but it may not always be necessary to use the Gmb for each service. MBMS service can be delivered to user equipment (UE) 116, 128 such as a mobile terminal over GERAN 130 or UTRAN 118.

The architecture assumes the use of IP multicast at the reference point Gi. The MBMS data source has only one connection to the IP backbone. The reference point from the content provider to the BM-SC 110 is currently not standardized as it might become too complex or restrictive for service creation. For example, this may be a reference point between the BM-SC 110 and an authoring system, or the authoring functionality may be distributed between both entities. The same architecture provides MBMS broadcast services mainly by using the transport functions. The user individual SGSN functions are not required. Instead each individual broadcast service is configured in the SGSN 120.

The SGSN 120 may use CAMEL (Customised Application for Mobile network Enhanced Logic) to handle pre-paid services, e.g. credit checking for on-line charging. The Cell Broadcast Center (CBC) 102 may be used to announce MBMS services to the users. The BM-SC 110 may exploit OSA-SCS 112 to interact with third parties. For the terminal split, MBMS shall be able to interoperate with an IP multicast client software on the terminal. More detailed information about MBMS service activation/release models, data transfer, functionalities of network elements, radio interface bearer set-up/release, QoS (Quality of Service), security issues etc. can be found in the references [1] and [2].

As depicted in FIG. 1, GERAN 130 can be connected to the core network either through Iu or Gb interface. Iu interface connects the GERAN 130 to 3G SGSN 120. The protocols and the functional split between the radio access network and the core network are in that case the same for UTRAN 118 and GERAN 130. See FIG. 2 for the illustration of user plane protocol stack in Iu mode. Packet Data Convergence Protocol (PDCP) maps higher-level characteristics onto the characteristics of the underlying radio-interface protocols thus providing protocol transparency for higher-layer protocols. GPRS Tunnelling Protocol for the user plane (GTP-U) tunnels user data between UTRAN and the 3G SGSN, and between the GSNs in the backbone network. GTP encapsulates all PDP (Packet Data Protocol) PDUs (Protocol Data Unit). UDP/IP (User Datagram Protocol, Internet Protocol) are the backbone network protocols used for routing user data and control signalling. The RLC (Radio Link Control) protocol provides logical link control over the radio interface. There may be several simultaneous RLC links per terminal. Medium Access Control (MAC) controls the access signalling (request and grant) procedures for the radio channel.

The Gb interface on the other hand connects the GERAN 130 to 2G SGSN 120 and the functional split between the BSS 130 (Base Station System, ˜radio access network e.g. GERAN) and the SGSN 120 is different from the UTRAN/GERAN Iu mode. For example, ciphering is done in the core network (SGSN). Also the protocol architecture illustrated in FIG. 3 being described more thoroughly later in the text and the procedures between the SGSN and the BSS differ from the Iu case.

As the MBMS standardization work has so far been mainly focused on the Iu interface, the procedures presented in the architecture and functional description [2] are applicable only for UTRAN/GERAN Iu mode. Therefore, new functionality is needed if MBMS service is introduced into GERAN Gb interface. One specific problem is that with Gb interface there is no RAB (Radio Access Bearer) concept in the same way as in the Iu interface. Thus the procedures corresponding to the MBMS RAB setup, release etc. do not apply to the Gb interface. The SGSN establishes RABs basically on demand when there exists data to be transferred to the users.

An option for MBMS (broadcast) service activation and RAB set-up is presented as an illustration in FIG. 4 in reference to [2]. At a SGSN re-start or when a new MBMS broadcast service is set-up, see phase 402, the SGSN 120 requests a creation of an MBMS context and GTP tunnel on the GGSN 122 for each RNC/BSC (Radio Network Controller, Base Station Controller) within the service area. In phase 404 the GGSN 122 joins the relevant IP multicast to connect the BM-SC 110 if not connected already. In phase 410 the GGSN confirms the establishment of the MBMS context. In phase 412 MBMS data is sent to the GGSN 122 and in phase 414 forwarded to the SGSN 120 through all related Gn/Gp tunnels. In phases 416 and 418 a RAB (Radio Access Bearer) is created for each MBMS context by utilizing assignment request and response procedures. In phase 420 MBMS notification is sent to terminals being finally followed by the transmission of actual MBMS data in phases 422 and 424. In a corresponding multicast case (not shown), the terminal first transmits an Activate MBMS Context Request to the SGSN 120. The IP multicast address identifies the MBMS multicast service, which the terminal wants to join. The SGSN 120 validates the Activate MBMS Context Request. The MBMS context(s) store the parameters of the activated MBMS multicast service. If said terminal is the first one activating this specific MBMS multicast service on the routing area, the SGSN 120 determines the RNCs serving the routing area and requests for each the creation of an MBMS context on the GGSN 122 and the establishment of a GTP tunnel between the SGSN 120 and the GGSN 122. Later in connection with the RAB set-up, the SGSN 120 sends MBMS RAB Request (indicating e.g. QoS parameters) only to the RNCs serving the Routing Areas in which there are terminals which have joined the MBMS context.

In addition to arrant data delivery issues, also other aspects remain open in exploiting the Gb interface. For example, various applications must not interfere with each other when the BSS 130 schedules the data transfer over the air interface. Normally both the SGSN 120 and BSS 130 have data buffers for data transmission. If the data buffer in the BSS 130 fills up because of an overwhelming data flow by a certain MBMS service, the transmission of other services using the same data transmission buffer is also negatively affected (transmission delays etc). This is one issue that must be taken into account if MBMS is introduced to the GERAN A/Gb mode as currently expected.

### DISCLOSURE OF INVENTION

An object of the present invention is to alleviate the aforesaid deficiencies and provide an addressing mechanism for routing MBMS data over the Gb interface between the SGSN 120 and BSS 130. Additionally, a flow control mechanism is needed for MBMS services as the bitrate they typically require may be relatively high and varying causing potential problems also for other traffic delivered by the BSS 130. The object is achieved by introducing a concept of MBMS-specific packet flow context (PFC), called MBPFC (Multicast/Broadcast Packet Flow Context) hereinafter, to the Gb interface with functionalities partly corresponding the ones MBMS RAB provides in the Iu mode. The proposed concept thus allows reuse of some already-existing procedures and resolves certain Gb interface specific problems.

The term “BSS” (Base Station System) refers to a radio access network, e.g. a GERAN, comprising at least one base station and radio network controller/base station controller.

The term “Gb” refers to an interface between the BSS and second-generation packet-switched core network.

A method according to the invention for routing MBMS (Multicast/Broadcast Multimedia Service) service data from a first network entity to a second network entity is characterized in that the method has the steps of
defining a packet flow identifier (PFI) associated to at least one MBMS service or a group of terminals,
creating a packet flow context (PFC) for said MBMS service or group of terminals identified by said PFI,
transferring the MBMS service data over the Gb interface by utilizing said PFC.

In another aspect of the invention, a system comprising a Gb interface between a first and a second network entity, is characterized in that in order to route MBMS service data over said Gb interface said first and second network entities are arranged to negotiate a common packet flow identifier (PFI) for said MBMS service or a group of terminals and said second network element is arranged to create a packet flow context (PFC) for said service or group of terminals.

In a further aspect of the invention, a device functionally connected to a Gb interface, is characterized in that in order to route MBMS (Multicast/Broadcast Multimedia Service) service data over the Gb interface it is arranged to define a packet flow identifier (PFI) associated to at least one MBMS service or a group of terminals, to create a packet flow context (PFC) for said MBMS service or group of terminals identified by said packet flow identifier, and to transfer the MBMS service data over the Gb interface by utilizing said packet flow context.

Such a device may be e.g. a network element such as the SGSN operable in a second-generation packet-switched core network and comprise standard processing (e.g. processor, micro-controller, signal processor, programmable logic), memory (e.g. one or more memory chips) and data transfer means (e.g. fixed data interface with controller) configured to execute the method of the invention.

The accompanying dependent claims describe embodiments of the invention.

### BRIEF DESCRIPTION OF THE DRAWINGS

In the following, the invention is described in more detail by reference to the attached drawings, wherein

FIG. 1 is a block diagram of an MBMS capable system.

FIG. 2 is a block diagram of the protocol architecture (user plane) in Iu mode.

FIG. 3 is a block diagram of the protocol architecture (user/control plane) in A/Gb mode.

FIG. 4 is a signalling chart disclosing one option for MBMS Broadcast service activation and RAB set-up.

FIG. 5A is a signalling chart disclosing the messaging applied in the creation of MBPFC.

FIG. 5B is a signalling chart disclosing the messaging applied in the deletion of MBPFC.

FIG. 6 illustrates an option for the message structures applied in the MBPFC creation and deletion.

FIG. 7 presents the layers for controlling the flow of MBMS data routed over the Gb interface.

FIG. 8 discloses a flow diagram of a method for routing and controlling the flow of MBMS data in accordance with the invention.

### BEST MODE FOR CARRYING OUT THE INVENTION

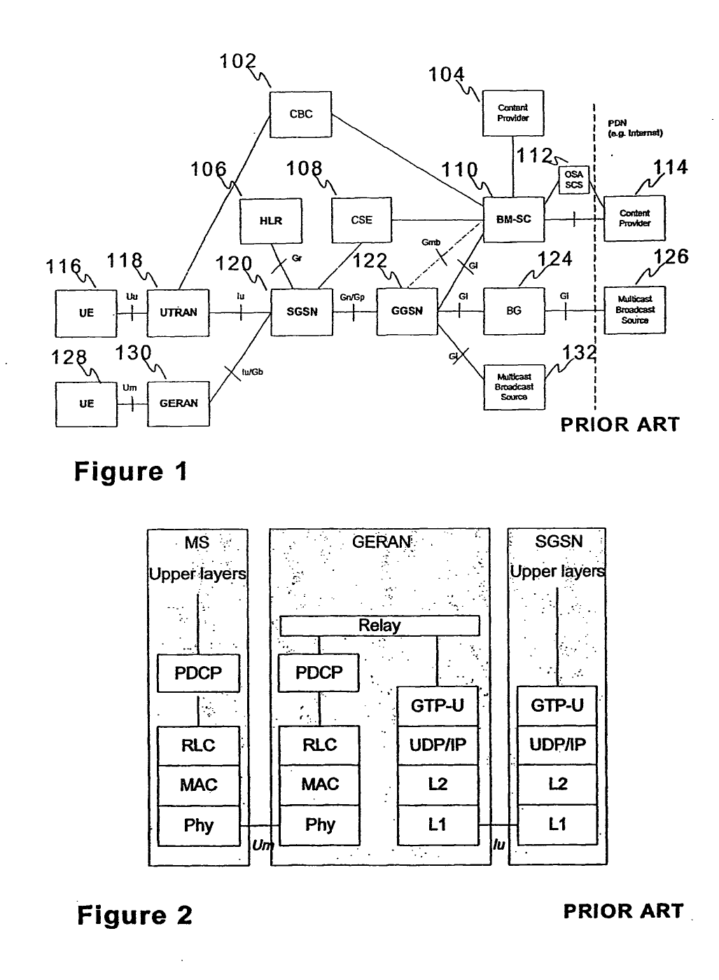

FIGS. 1-4 were already covered in conjunction with the description of the prior art. The signalling chart in FIG. 4 presenting the MBMS service activation is feasible also in this case when it comes to phases 402-414 preceding the RAB set-up.

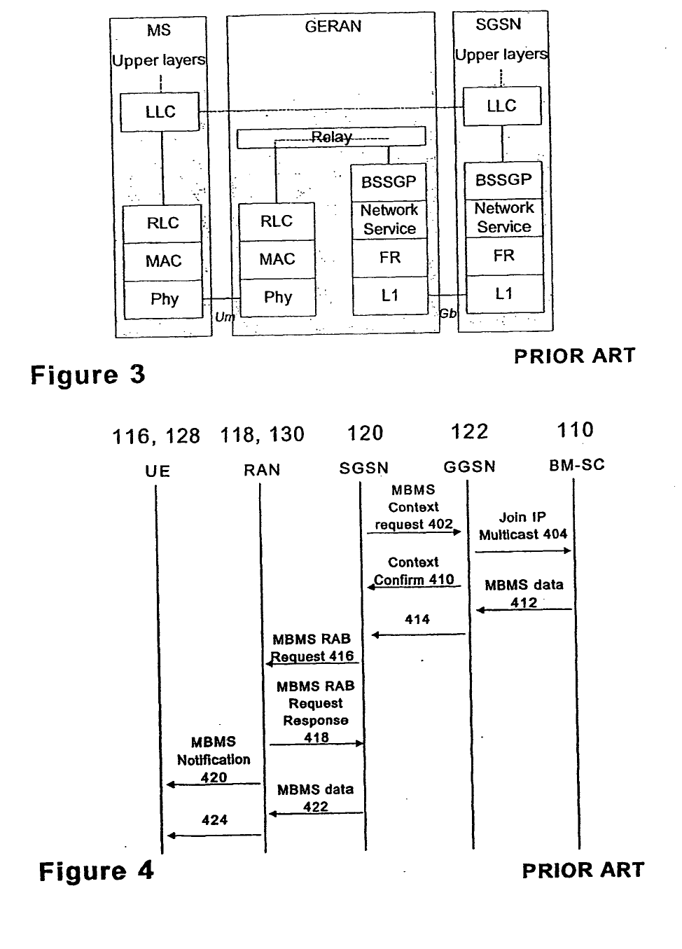

The protocol stack of the Gb interface as depicted in FIG. 3 contains layers titled BSSGP (BaseStation System GPRS Protocol) and Network Service (NS). BSSGP controls the transfer of LLC (Logical Link Control) frames passed between an SGSN and a terminal across the Gb interface. Accordingly, the primary functions of the BSSGP include the provision by an SGSN 120 to a BSS 130 of radio related information used by the RLC/MAC function, the provision by a BSS 130 to an SGSN 120 of radio related information derived from the RLC/MAC function and the provision of functionality to enable two physically distinct nodes, an SGSN 120 and a BSS 130, to operate node management control functions. BSSGP Virtual Connections (BVC) provide communication paths between BSSGP entities. BVCs are identified by means of a BSSGP Virtual Connection Identifier (BVCI) which has end-to-end significance across the Gb interface. Each BVCI is unique between two peer Network Service Entities. The Network Service is the entity which actually provides network service primitives allowing the transmission and reception of upper layer protocol data units between the BSS 130 and SGSN 120. The Network Service is based on the Frame Relay (FR) connection between the BSS 130 and the SGSN 120, and may multi-hop and traverse a network of Frame Relay switching nodes. Each Network Service Entity is identified by means of a Network Service Entity Identifier (NSEI) which together with the BVCI uniquely identifies a BSSGP Virtual Connection within an SGSN 120. The SGSN 120 needs not to be updated when a new cell (BVC/BVCI) is added to the BSS (NSEI) 130. The NSEI is used by the BSS 130 and the SGSN 120 to determine the NS-VCs that provide service to the BVC. Logical Link Control (LLC) offers a ciphered logical link being independent of the underlying radio interface protocols in order to allow introduction of alternative GPRS radio solutions with minimum changes to the NSS. RLC/MAC contains two functions: The Radio Link Control function provides a radio-solution-dependent reliable link. The Medium Access Control function controls the access signalling (request and grant) procedures for the radio channel, and the mapping of LLC frames onto the physical channel. See the references [3], [4] and [5] for further details about GPRS protocol stacks, PDUs, BSS contexts, flow control as well as common GPRS attach/detach and PDP context activation/deactivation procedures.

The SGSN 120 can provide the BSS 130 with information related to ongoing user data transmission. The information related to one terminal is stored in a BSS context. The BSS 130 may contain BSS contexts for several terminals. A BSS context contains a number of BSS packet flow (PFC) contexts. A PFC is created with DOWNLOAD-BSS-PFC (optional), CREATE-BSS-PFC and CREATE-BSS-PFC-ACK PDUs as described in the reference [4]. A BSS packet flow context (PFC) is identified by a packet flow identifier (PFI). There are four pre-defined packet flows identified by four reserved packet flow identifier values. One predefined packet flow is used for best-effort service, one for signalling, one for SMS (Short Message Service), and one for LCS (Location Services). The BSS 130 shall not negotiate BSS packet flow contexts for these pre-defined packet flows with the SGSN 120.

The flow control mechanism manages the transfer of BSSGP UNITDATA PDUs sent by the SGSN 120 over the Gb interface to the BSS 130. There is a downlink buffer for each BVC in the BSS 130 identified by a BVCI. UNITDATA PDU contains an LLC PDU to be transmitted across the radio interface to a terminal. The principle of the existing BSSGP flow control procedures is that the BSS 130 sends flow control parameters to the SGSN 120 thus allowing the SGSN 120 to locally control its transmission output in SGSN to BSS direction (flow control is used only in the downlink direction). There are different levels of flow control: PFC, MS (Mobile Station; corresponding to a terminal) and BVC level. The SGSN 120 shall always apply BVC and MS flow control whereas PFC flow control is optional. The BSS 130 controls the flow of UNITDATA PDUs to its BVC buffers by indicating to the SGSN the maximum allowed throughput for each BVC in a FLOW-CONTROL-BVC PDU. The BSS 130 controls the flow of UNITDATA PDUs to the BVC buffer of an individual terminal by indicating to the SGSN 120 the maximum allowed throughput for a certain TLLI (Temporary Link Level Identity) with FLOW-CONTROL-MS PDU. Additionally, FLOW-CONTROL-PFC PDU provides the SGSN 120 the flow control information regarding one or more PFC(s) of a given terminal. The SGSN 120 applies first PFC (if negotiated), then MS and finally BVC level flow control. If an LLC PDU to be included in a UNITDATA PDU passes all applied levels of flow control it is forwarded to lower protocol layers to be transferred to the BSS.

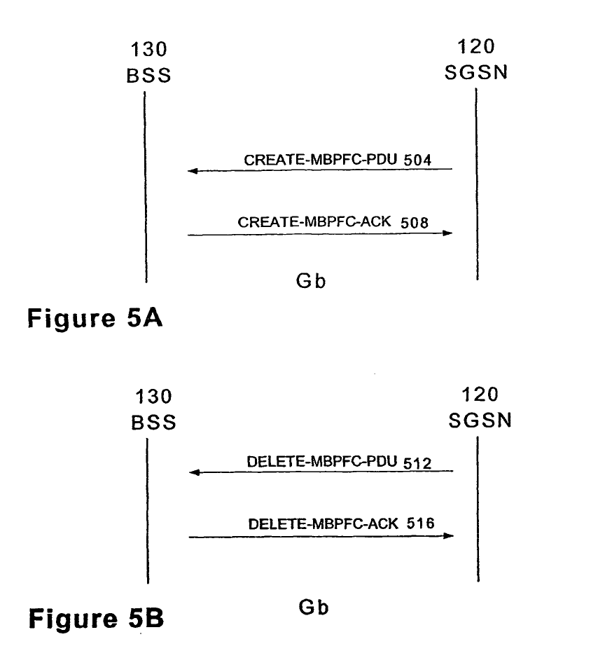

FIGS. 5-7 disclose one option for enabling MBMS data routing and flow control between the SGSN 120 and BSS 130 in accordance with the invention. In a general sense, a procedure partly congruent with the PFC concept described above can be applied by creating a MBPFC for each MBMS service, a group of services or a group of terminals. From the SGSN's standpoint said group of terminals may, for example, belong to a same multicast group and reside behind a common BVC. The group, which typically contains at least two terminals, may receive data from a single source, e.g. an MBMS service, or from multiple sources. Occuring randomly it is still possible to have only one user (˜one terminal) in the group though. In any case, the MBPFC is not logically connected to any individual terminal/associated with any individual TLLI (or TMSI/P-TMSI). In a multicast scenario the group for which the MBPFC is logically connected may be identified by a specific ID (e.g. a multicast ID). An MBMS specific PFI such as the multicast ID can also be sent to the terminals belonging to the multicast group for identifying the incoming MBMS flow. However, this may not be necessary as the identification can also be done in some other way (MBMS ID etc). The main use of an MBPFC is according to the invention to serve as an addressing mechanism between the SGSN 120 and the BSS 130 and facilitate using flow control in the Gb interface. In the BSS 130 the MBPFC is mapped to an appropriate logical channel so that the announced MBMS service is sent on the channel indicated to users in the service announcement procedure, wherein network broadcasts information e.g. about the frequency, time slot, and possibly TDMA frame when a particular service is scheduled over the radio interface.

The creation of an MBPFC can be executed as follows, see FIG. 5A. The SGSN 120 may initiate the procedure without any specific trigger from the BSS 130 side. For example, when the network establishes a new MBMS service or when the data is actually to be transferred the SGSN 120 initiates the creation of an MBPFC relating to the service/multicast group. This can be done in conjunction with the service announcement or later on. The SGSN 120 requests for the creation of the MBPFC by sending a CREATE-MBPFC PDU 504 to the BSS 130 including a PFI to be used for the PFC identification. The BSS 130 (in the GERAN case the network elements within the BSS executing this task are the RNCs), responds with a CREATE-MBPFC-ACK PDU 508 or corresponding NACK if the MBPFC cannot be created. As the proposed method is reminiscent of the one for creating a standard PFC with DOWNLOAD-BSS-PFC (optional), CREATE-BSS-PFC and CREATE-BSS-PFC-ACK messages, the existing standard procedure can also be exploited in this MBMS specific case, anyhow recalling that the essential difference is founded on a fact that the MBPFC is not logically connected to an individual terminal unlike the standard PFC. The network maps the PFC/PFI to a MBMS service/multicast group and it is also possible, although not advisable, to position all MBMS services into a single MBPFC. In that case different services cannot be treated independently and they may delay each other etc. The SGSN 120 and BSS 130 maintain entities, e.g. memory tables, of existing MBMS service/multicast group<->PFC/PFI mappings in order to route and control the flow of the data to be transferred and, in the BSS 130, to further pass the received data over an appropriate (e.g. announced) logical channel to terminal(s) either as a broadcast or PTM (Point-To-Multipoint, e.g. multicast) transmission.

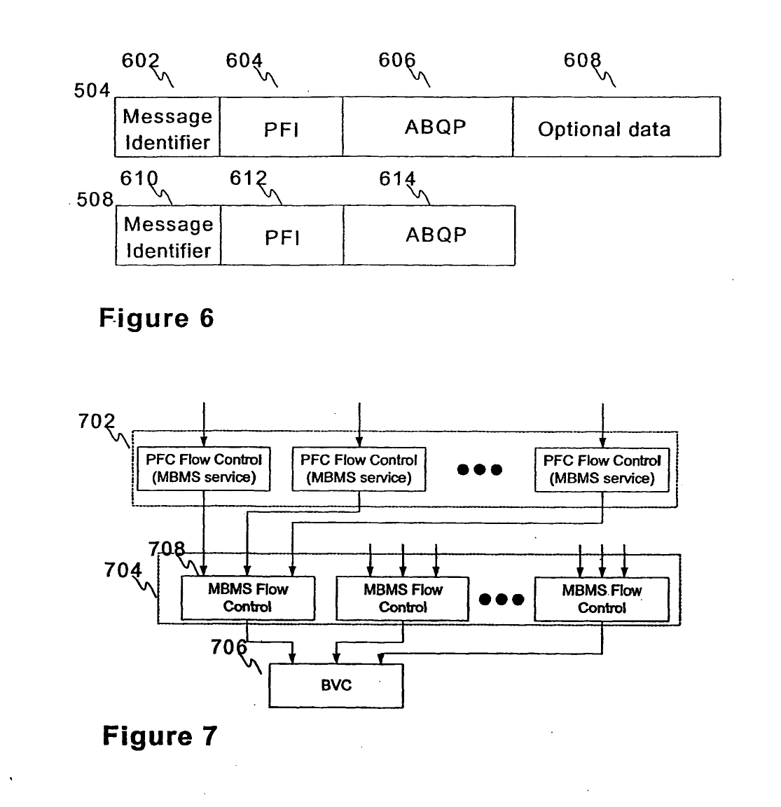

FIG. 6 discloses an option for the structure of messages applied in the FIG. 5A. CREATE-MBPFC PDU 504 includes fields for a message type identifier 602 e.g. a PDU type, PFI 604, ABQP 606 which is an Aggregate BSS QoS Profile (ABQP) defining the QoS agreed for the PFC (see the reference [5]) and optional data 608 such as optional IDs or group (e.g. terminals belonging to the same multicast group) definitions/identification etc. CREATE-MBPFC-ACK PDU 508 includes corresponding fields for a type identifier 610, a PFI 612 and ABQP 614 that may be restricted by the BSS 130 based on its current status and capabilities. Correspondingly, if NACK message is transmitted instead of ACK, a cause field can be included in the NACK to indicate the specific reason for rejecting the MBPFC creation as in a standard PFC case described in the reference [4].

MBPFC deletion can be executed respectively, see FIG. 5B. The SGSN 120 requests the deletion when e.g. the service delivery has been ceased by transmitting a message DELETE-MBPFC 512 to the BSS 130 that acknowledges the request with DELETE-MBPFC ACK 516. It's also possible that the BSS 130 deletes the MBPFC for some reason (e.g. lack of data transfer, memory or processing resources) and then informs the SGSN 120 about the executed deletion with a message, e.g. DELETE-MBPFC ACK 516. The message internals are not described here as they are mostly in conformity with the ones presented for the creation of an MBPFC including at least a message ID and TFI for the identification purposes.

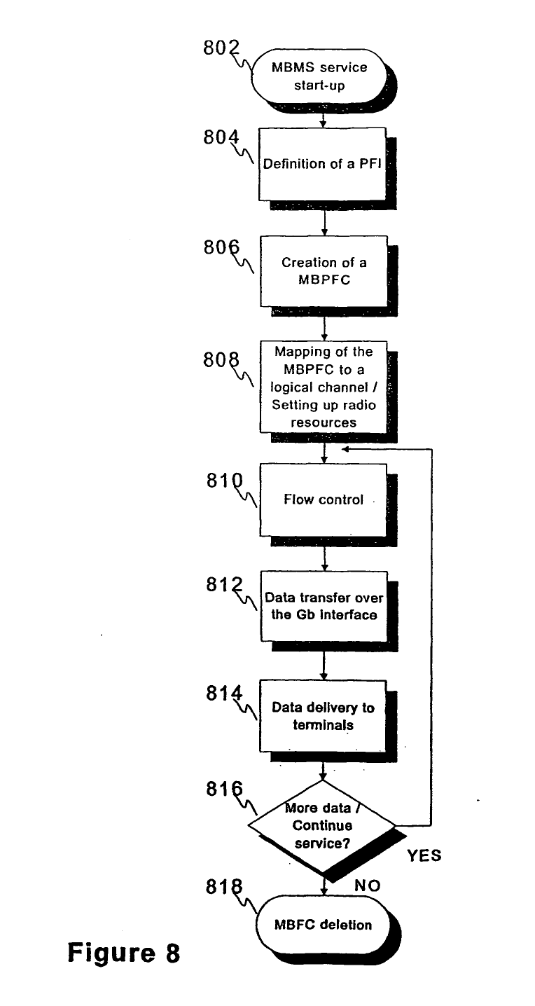

The SGSN 120 shall preferably perform flow control on each BVC, on each MBPFC and on some/all MBMS services as a whole, see FIG. 7. The flow control is performed first on each LLC-PDU (to be included in a UNITDATA PDU) by an MBPFC specific flow control mechanism 702, then by an aggregate flow control mechanism 704 and finally by a BVC flow control mechanism 706. BVC flow control (typically corresponding a cell) parameters concerning both standard PFCs as well as MBPFCs are received from the BSS 130 in a FLOW-CONTROL-BVC PDU described in the reference [4]. MBPFC flow control parameters can in principle be received from the BSS in a FLOW-CONTROL-PFC message as in a normal PFC case but the binding of the PFC with an individual terminal does not naturally apply. However, the BSS 130 may, for example, estimate an average profile of terminals receiving the services and inform the profile or relating parameters to the SGSN 120 for derivation of MBPFC specific flow control definitions. On the other hand, a set of rules may have been programmed in the BSS 130 indicating desired parameters (e.g. limit values for data leakage) for receiving services of varying types and based on that information, provide MBPFC specific parameters to the SGSN 120. As an third option, the SGSN 120 may define MBPFC flow control parameters based on some service related data or its current status (e.g. load). An entity called MBMS service block 708 may be created, under which there would be a number of MBPFCs carrying different MBMS services, to form an aggregate flow control level 704 comprising at least one block 708 but one option is to perform only PFC and BVCI flow control resulting that the aggregate level 704 in FIG. 7 does not exist. Secondly, if only a single PFC is created for all MBMS services as mentioned earlier, the situation remains the same. The SGSN 120 may construct the MBMS service blocks 708 by, for example, dividing the MBMS services into a number of groups (linked to blocks) based on the information about service/content type, content provider and service delivery requirements. This information, which can also be utilized in the creation of MBPFC flow control definitions, may be received, from a network element like the GGSN 122 or it can be derived internally either explicitly or implicitly from the MBMS data or relating ancillary information.

A method applying the principles described hereinbefore is presented in FIG. 8. First, at a MBMS service start-up 802 or, for example, when the SGSN 120 has actually received data to be delivered to terminals, a PFI is defined 804 for the service identification and a corresponding PFC (MBPFC) is created 806 in the BSS 130, assigned by the SGSN 120. In practice, the order of phases 804 and 806 is not a relevant issue as long as the MBPFC and PFI are created as a result. Next, the radio resources between the BSS and terminals are reserved and set up in phase 808. This phase may include transmitting of MBMS notifications. Flow control is performed 810 before transferring the data over the Gb interface 812 from the SGSN 120 to the BSS 130 and finally over the air interface 814 to the terminals. If more data appears to be delivered 816 the phases of flow control 810 and data transfer 812, 814 may be repeated. When no more data exists, for example, for a predetermined time period or the service is ramped down, the MBPFC may be deleted 818. It should be noted that the order of the aforementioned phases may be changed and some phases can even be altered or combined together without diverging from the concept of the invention. For example, phase 808 may be executed just before phase 814 if logical channels/radio resources are to be allocated in connection with actual data delivery.

The scope of the invention is disclosed in the following independent claims. However, utilized messages, network elements, method and procedural steps, etc., may vary depending on the current scenario, still converging to the basic ideas of the invention. Therefore, the invention is not strictly limited to the embodiments described above.

### REFERENCES

[1] 3GPP TS 22.146 V6.0.0 Technical Specification Group Services and System Aspects; Multimedia Broadcast/Multicast Service; Stage 1 Release 6 (2002-6), URL: http://www.3gpp.org, 3GPP 2002

[2] 3GPP TR 23.846 V1.2.0 Technical Specification Group Services and System Aspects; MBMS; architecture and functional description, Release 6 (2002-9), 3GPP 2002

[3] 3GPP TS 48.016 v5.1.0 Technical Specification Group GSM/EDGE Radio Access Network; Base Station System (BSS)—Serving GPRS Support Node (SGSN) interface; Network Service, Release 5 (2001-12)

[4] 3GPP TS 48.018, v.5.5.0 Technical Specification Group GSM/EDGE Radio Access Network; GPRS; Base Station System (BSS)—Serving GPRS Support Node (SGSN); BSS GPRS Protocol (BSSGP) Release 5 (2002-9)

[5] 3GPP TS 23.060 V5.3.0 Technical Specification Group Services and System Aspects; GPRS; Service description; Stage 2 Release 5 (2002-9)

1. Method for routing service data of a Multicast/Broadcast Multimedia Service from a first network entity (120) to a second network entity (130), characterized in that said method has the steps of
defining a packet flow identifier (PFI) associated to at least one MBMS or a group of terminals (804),
creating a packet flow context (PFC) for said MBMS or group of terminals identified by said packet flow identifier (806),
transferring the service data of the MBMS over a Gb interface by utilizing said PFC (812).

2. The method of claim 1, characterized in that it further comprises a step wherein the PFC is mapped to an appropriate logical channel indicated by a service announcement of the MBMS (808).

3. The method of claim 1, characterized in that it further comprises a step, wherein the first network entity performs flow control of the service data of the MBMS on PFC and Base Station System General Packet Radio Service (GPRS) Protocol (BSSGP) Virtual Connection (BVC) levels (810).

4. The method of claim 3, characterized in that said flow control is additionally performed on a level (704) located between said PFC and BVC levels, said level (704) comprising at least one block (708) whereto at least one PFC is logically connected.

5. The method of claim 1, characterized in that terminals in said group of terminals belong to a same multicast group.

6. The method of claim 1, characterized in that terminals in said group of terminals receive data from at least one common source.

7. The method of claim 1, characterized in that said creation of the PFC comprises a step wherein a PFC request (504) is transmitted to a network entity (130) performing said creation.

8. The method of claim 3, characterized in that at least part of plural flow control parameters are received from a Base Station Subsystem (BSS) or Gateway GPRS Support Node (GGSN).

9. The method of claim 1, characterized in that transferred data of the MBMS is identified by said second network entity (130) on the basis of said PFI.

10. System comprising a Gb interface between a first network entity (120) and a second network entity (130), characterized in that in order to route service data of a Multicast/Broadcast Multimedia Service (MBMS) over said Gb interface said first network entity (120) and said second network entity (130) are arranged to negotiate a common packet flow identifier (PFI) for said MBMS or a group of terminals and said second network element (130) is arranged to create a packet flow context (PFC) for said MBMS or group of terminals.

11. The system of claim 10, characterized in that said system is arranged to perform flow control of said service data of said MBMS at least on PFC and Base Station System General Packet Radio Service (GPRS) Protocol (BSSGP) Virtual Connection (BVC) levels (702, 706) prior to transmission over the Gb interface.

12. The system of claim 11, characterized in that said flow control further comprises a level (704) located between said PFC (702) and BVC (706) levels, said level (704) comprising at least one block (708) whereto at least one PFC is logically connected.

13. The system of claim 10, characterized in that said first network entity (120) is substantially a Serving GPRS Support Node and said second network entity is substantially a GSM/EDGE Radio Access Network (130) (GERAN).

14. The system of claim 10, characterized in that said first network entity (120) is arranged to request said creation of the PFC.

15. The system of claim 10, characterized in that it is arranged to map the PFC to an appropriate logical channel indicated by MBMS service announcement.

16. The system of claim 10, characterized in that terminals in said group of terminals belong to a same multicast group.

17. A device functionally connected to a Gb interface, characterized in that in order to route service data of a Multicast/Broadcast Multimedia Service (MBMS) data over the Gb interface it is arranged to define a packet flow identifier (PFI) associated to at least one MBMS service or a group of terminals, to create a packet flow context (PFC) for said MBMS service or group of terminals identified by said packet flow identifier, and to transfer the service data of the MBMS over the Gb interface by utilizing said packet flow context.
